(19) United States
(12) Patent Application Publication
(10) Pub. No.: US 2016/0370468 A1
(43) Pub. Date: Dec. 22, 2016

(54) Data Processing Apparatus For Measuring ILS Radio Wave And Method Therefor

(71) Applicant: KOREA AIRPORTS CORPORATION, Seoul (KR)

(72) Inventor: Woo Ram Son, Seoul (KR)

(21) Appl. No.: 14/902,047

(22) PCT Filed: Jul. 1, 2014
(86) PCT No.: PCT/KR2014/005850

§ 371 Date: Dec. 30, 2015

(30) Foreign Application Priority Data
Jul. 2, 2013 (KR) 10-2013-0077263

(51) Int. Cl. G01S 19/15; G08G 5/02; G01S 1/16

(52) U.S. Cl. CPC G01S 19/15; G01S 1/16; G08G 5/025

(57) ABSTRACT

A data processing device and method are provided for measuring a radio wave of an instrument landing system (ILS). To elaborate, the device includes: a location receiver configured to receive location data of an ILS antenna measured by a GPS receiver; a radio wave receiver configured to receive radio wave data measured by the ILS antenna; a data processor configured to perform mutual mapping between the location data and the radio wave data; and a storage configured to store mapping result data of the data processor. The data processor generates a 3D image of the radio wave data measured from multiple measurement paths of the ILS antenna located at a certain point on the basis of the mapping result data.

### TECHNICAL FIELD

The present disclosure relates to a data processing device and data processing method for measuring a radio wave of an instrument landing system (hereinafter, referred to as “ILS”), and more particularly, to a data processing device and data processing method for measuring a multi-path radio wave of an ILS using a GPS.

### BACKGROUND

An ILS is a system to inform pilots of a direction and angle of an aircraft approaching a runway by generating radio beams from a device installed on the ground with respect to the approaching aircraft for approach or landing.

FIG. 1 is a configuration view illustrating a configuration of a conventional ILS technology.

The ILS is a conventional technology for measuring a signal for precise approach and landing of an aircraft 5. The ILS includes a localizer 1 configured to provide information of a centerline of a runway 4, a glide path 2 configured to provide information of a glide slope (or glide angle), and a marker beacon 3 configured to provide location information.

The localizer 1 is configured as a pair including a transmitter installed on the ground and a receiver of the aircraft 5. If the transmitter modulates audio signals into signals of 90 Hz and 150 Hz using a carrier having a frequency of 108 MHz to 112 MHz and transmits the signals through an antenna, the receiver of the aircraft 5 receives the signals. The localizer 1 sets a horizontal approach path for landing along the locations where the signals of 90 Hz and 150 Hz appear, and, thus, provides the aircraft 5 approaching the runway 4 with information of the centerline of the runway 4.

Similarly to the localizer 1, the glide path 2 is a facility configured to provide information of a vertical approach path for landing of the aircraft 5, and provides the aircraft 5 approaching the runway 4 for landing with information of a glide slope of 3 degrees as the safest landing angle.

The marker beacon 3 is configured to inform the pilot that the aircraft 5 passes through a specific location during an airway flight or instrument flight of the aircraft 5, and includes the marker beacon 3 on the ground and the receiver of the aircraft 5.

According to signal characteristics of the ILS, signals respectively transmitted from multiple array antennas are spatially modulated to generate desired signals. If the generated signals are abnormal, an aircraft crash may occur. Actually, the Korean Airline crash in Guam occurred since abnormal ILS signals were received.

There is a conventional ILS flight testing system for solving the above-described problem. The flight testing system is an ILS signal measurement system using an actual aircraft and configured to measure ILS signals in the air and check abnormality of the signals during flight similar to landing of the aircraft. However, the flight testing system requires high cost for one-time measurement, and the number of times of measurement per year is limited to 2 times on average. Further, if any abnormality occurs in a radio wave signal from a facility, the flight testing system cannot immediately detect the abnormality. Furthermore, the flight testing system cannot be used for setup of the facility but can be used only for simply checking abnormality.

Further, there is a conventional signal measurement technology for measuring ILS signals on the ground. The conventional ILS signal measurement technology is a technology for measuring spatially modulated ILS signals at specific fixed locations using an ILS antenna and an ILS receiver and checking abnormality of the signals.

FIG. 2 illustrates the conventional ILS signal measurement technology for measuring ILS signals.

However, at present, multi-path padding generated or to be generated by new buildings built inside and outside an airport influences spatial modulation of ILS signals and thus causes signal distortion. To prepare for this, it is necessary to construct a 3D database for imaging a 3D radio wave pattern by measurement of ILS signals from multiple measurement paths instead of conventional measurement of 1D radio wave signals from a fixed point.

In this regard, Korean Patent Laid-open Publication No. 10-2013-0058824 (entitled “Passive ranging module”) discloses a conventional location measurement technology for precise approach and landing of an aircraft.

### SUMMARY

There are provided a data processing device for ILS radio wave measurement and a method thereof for solving ILS signal distortion caused by multi-path padding generated by new buildings built inside and outside an airport.

Further, there are provided a data processing device for ILS radio wave measurement and a method thereof for constructing a 3D database for imaging a 3D radio wave pattern by measurement of ILS signals from multiple measurement paths instead of conventional measurement of 1D radio wave signals from a fixed point.

However, problems to be solved by the present disclosure are not limited to the above-described problems. There may be other problems to be solved by the present disclosure.

In accordance with one exemplary embodiment, there is provided a data processing device for measuring a radio wave of an instrument landing system (ILS). The data processing device may include a location receiver configured to receive location data of an ILS antenna; a radio wave receiver configured to receive radio wave data measured by the ILS antenna; a data processor configured to perform mutual mapping between the location data and the radio wave data; and a storage configured to store mapping result data of the data processor. Wherein the data processor may generate a 3D image of the radio wave data measured from multiple measurement paths of the ILS antenna located at a certain point on the basis of the mapping result data, and the location data may be measured by a GPS receiver.

In accordance with another example embodiment, there is provided a data processing method for measuring a radio wave of an instrument landing system (ILS). The data processing method may include receiving location data of an ILS antenna; receiving radio wave data measured by the ILS antenna; performing mutual mapping between the location data and the radio wave data; storing mapping result data; and generating a 3D image of the radio wave data measured from multiple measurement paths of the ILS antenna located at a certain point on the basis of the mapping result data. Wherein the location data may be measured by a GPS receiver.

According to any one of the above-described exemplary embodiments of the present disclosure, a measurement location angle is provided to ILS signal measuring data, and, thus, even if a measurement location is any random point, it is possible to measure ILS signals from multiple measurement paths instead of a fixed point.

Further, according to any one of the above-described exemplary embodiments of the present disclosure, it is possible to provide an interface which enables a GPS receiver, an ILS receiver, and a display device to easily communicate with each other.

Furthermore, Further, according to any one of the above-described exemplary embodiments of the present disclosure, it is possible to construct a multi-path database by measurement from multiple measurement paths, and also possible to construct a 3D database on the basis of the multi-path database. Moreover, it is possible to image a 3D radio wave pattern of ILS signals on the basis of the 3D database.

### BRIEF DESCRIPTION OF THE DRAWINGS

FIG. 1 is a configuration view illustrating a configuration of an ILS technology;

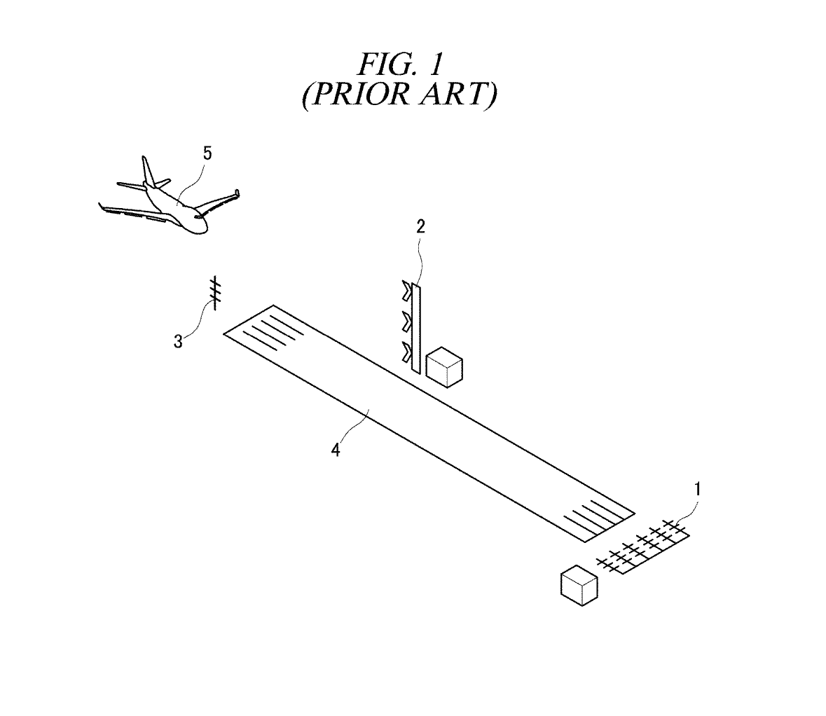

FIG. 2 is a configuration view illustrating a conventional ILS signal measurement technology;

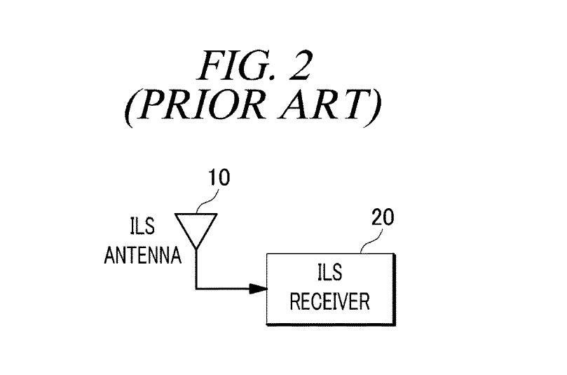

FIG. 3 illustrates an instrument landing system including a data processing device in accordance with an exemplary embodiment of the present disclosure;

FIG. 4 illustrates a configuration of a data processing device in accordance with an exemplary embodiment of the present disclosure;

FIG. 5 is a flowchart provided to describe a method for processing data for radio wave measurement by a data processing device in accordance with an exemplary embodiment of the present disclosure; and

FIG. 6 illustrates an example of an image implemented by data processing in accordance with an exemplary embodiment of the present disclosure.

### DETAILED DESCRIPTION

Hereinafter, embodiments of the present disclosure will be described in detail with reference to the accompanying drawings so that the present disclosure may be readily implemented by those skilled in the art. However, it is to be noted that the present disclosure is not limited to the embodiments but can be embodied in various other ways. In drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element.

Further, through the whole document, the term “comprises or includes” and/or “comprising or including” used in the document means that one or more other components, steps, operation and/or existence or addition of elements are not excluded in addition to the described components, steps, operation and/or elements unless context dictates otherwise. Through the whole document, the term “step of” does not mean “step for”.

Through the whole document, the term “ILS antenna” includes all of antennas used to measure ILS radio wave signals. For example, the ILS antenna includes transmitting/receiving antennas in a localizer, a glide path, a marker beacon used for ILS technology.

The present disclosure relates to a data processing device for a signal measurement system of an instrument landing system (ILS) for precise approach and landing of an aircraft using a GPS signal, and more particularly, to a data processing device provided between a GPS receiver for measurement of a location and calculation of an angle, an ILS receiver for measurement of an ILS signal and a display device, and configured to function as an interface, perform data mapping and arithmetic function, and generate message data and transmit the message data to the display device.

The ILS includes a GPS antenna, a GPS receiver, an ILS antenna, an ILS receiver, a data processing device, and a display device. Since the GPS receiver and the ILS antenna are present at the same location, the GPS receiver may measure location data of the ILS antenna. Therefore, a measurement location of the GPS antenna and the GPS receiver to be described later means a location of the ILS antenna.

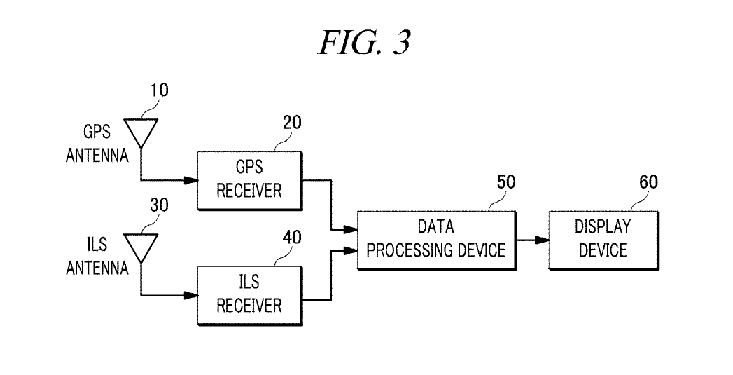

FIG. 3 illustrates an instrument landing system including a data processing device in accordance with an exemplary embodiment of the present disclosure.

A data processing device 50 in accordance with an exemplary embodiment of the present disclosure may be provided between a GPS receiver 20, an ILS receiver 40 and a display device 60.

The GPS receiver 20 is configured to measure location data of an ILS antenna 30 received by a GPS antenna 10. The GPS receiver 20 is connected to the GPS antenna 10 by a coaxial cable and connected to a location receiver of the data processing device 50 using the USB communication standard.

The ILS receiver 40 is configured to measure radio wave data received by the ILS antenna 30. The ILS receiver 40 is connected to the ILS antenna 30 by a coaxial cable and may be connected to a radio wave receiver of the data processing device 50 using the RS-232 communication standard.

The data processing device 50 adopts the communication standards of the GPS receiver 20 and the ILS receiver 40 and interprets a protocol of the transmitted data. Further, the data processing device 50 performs mutual mapping between location data of an ILS antenna present at a certain location acquired from the GPS receiver 20 and radio wave data acquired from the ILS receiver 40, and generates a 3D image on the basis of the mapping result. Further, the data processing device 50 transmits the 3D image to the display device.

Herein, in order to generate a multi-path 3D image, measurement locations may be changed not by installing the ILS antenna at a fixed place but by installing the ILS antenna at multiple places. Thus, it is possible to overcome the limitations of the conventional technology in which radio wave data needs to be measured at a fixed location.

Then, the display device 60 is configured to display the 3D image generated on the basis of the mapping result. A user can observe ILS radio wave data with more precision using the multi-path 3D image.

Hereinafter, components and operations of the data processing device 50 in accordance with an exemplary embodiment of the present disclosure will be described in detail.

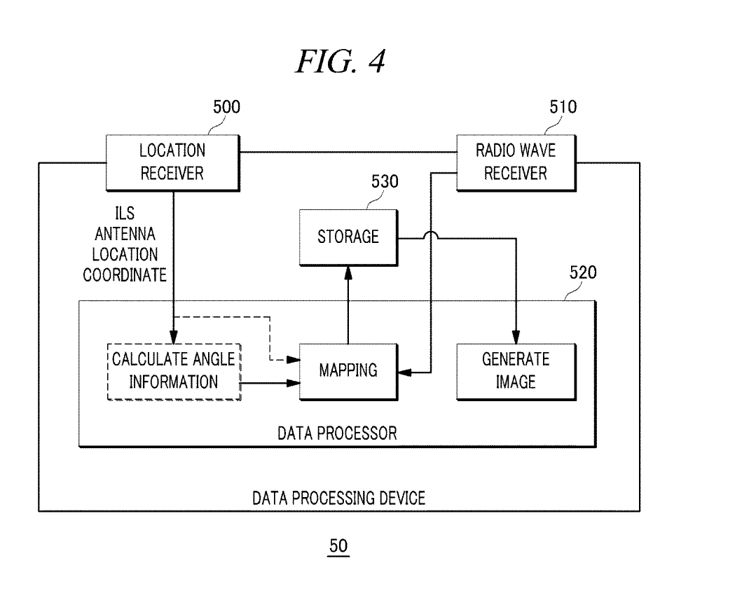

FIG. 4 illustrates a configuration of a data processing device in accordance with an exemplary embodiment of the present disclosure.

As illustrated in FIG. 4, the data processing device 50 includes a location receiver 500, a radio wave receiver 510, a data processor 520, and a storage 530.

The location receiver 500 receives location data of the ILS antenna 30 located at a certain point. The location receiver 500 collects location data of a location of the ILS antenna 30 from the GPS receiver 20. The location data includes location coordinates or angles of the ILS antenna 30. Herein, the location data may include an angle between a reference point and the ILS antenna 30.

Further, in accordance with another exemplary embodiment of the present disclosure, the location receiver 500 may receive location data at 1 PPS (pulse per second). Thus, it is possible to measure radio wave data with more precision by receiving radio wave data at 2 PPS through the radio wave receiver 510 and performing mutual mapping through the data processor 520.

The radio wave receiver 510 receives radio wave data measured by the ILS antenna 30. If the ILS antennas 30 are located at certain points, the ILS antenna 30 located at each point may transmit radio wave data slightly different from each other due to multi-path padding. The radio wave receiver 510 receives radio wave data of the ILS antenna 30. Further, in accordance with another exemplary embodiment of the present disclosure, the radio wave receiver 510 may receive location data at 2 PPS.

For communication between the GPS receiver 20 and the ILS receiver 40 using different communication standards from each other, the data processor 520 converts communication standards of the GPS receiver 20 and the ILS receiver 40, or interprets protocols of the received location data and radio wave data. By way of example, the GPS receiver 20 may use the USB communication standard and the ILS receiver 40 may use the RS-232 communication standard.

The data processor 520 calculates an angle of the ILS antenna 30 from a reference point by using the received location data. In this case, the location receiver 500 receives self-location measurement information of the ILS antenna 30 by using a location measurement technology, and the data processor 520 measures an angle of the ILS antenna 30 relative to a location of the reference point by comparison with previously stored location information of the reference point. Such an angle may be calculated by the data processor 520 itself, or may be an angle calculated by an external device and then received as location data by a receiver of the data processing device 50.

Further, the data processor 520 performs mutual mapping between the location data of the ILS antenna 30 received by the location receiver 500 and the radio wave data received by the radio wave receiver 510. In the conventional technology, radio wave data are measured at a fixed location regardless of a location of the ILS antenna 30. However, in an exemplary embodiment of the present disclosure, radio wave data are measured at various locations to add location data to the radio wave data. That is, the data processor 520 creates messages with the received location data and radio wave data. Herein, the location data may include location coordinates or angles of the ILS antenna 30.

If the location receiver 500 receives location data at 1 PPS and the radio wave receiver 510 receives radio wave data at 2 PPS, the data processor 520 may perform mutual mapping between the location data at 1 PPS and the radio wave data at 2 PPS at a ratio of 1 to 2. Further, this can be created into a message at 1 PPS. Thus, it is possible to guarantee the precision of the radio wave data.

The storage 530 stores mapping result data of the data processor 520. If the mapping result data of the ILS antenna 30 located at a certain point are stored in the storage 530, the data processor 510 may generate a 3D image using multiple mapping result data.

That is, the data processor 520 generates a 3D image with the radio wave data of the ILS antenna 30 using the mapping result data of the ILS antenna 30 located at a certain point or the message at 1 PPS.

Herein, the data processor 520 may generate an image using interpolation. The data processor 520 may generate an image by a method in which an ILS antenna is aware of two or more values at a certain distance among continuous variables of radio wave data due to an influence such as spatial interference and a certain function value satisfying them is determined to calculate a function value with respect to a value of a radio wave data variable between the two values.

Meanwhile, the data processing device 50 in accordance with an exemplary embodiment of the present disclosure may further include any one or more of a power switch, an initialization switch, a display unit, and a debugging connection unit.

The power switch (not illustrated) is a component configured to turn a power supply of the data processing device 50 on and off.

The initialization switch (not illustrated) is configured to restart the above-described operations of the radio wave receiver 510, the location receiver 500, and the data processor 520. An example of the initialization switch may include a reset button.

The display unit (not illustrated) is a component configured to display an operation status of the data processing device 50, and displays whether the data processing device 50 calculates location coordinates and angles, whether the data processing device 50 performs data mapping, or whether the data processing device 50 generates a 3D image.

The debugging connection unit (not illustrated) is a component connected to an external device for debugging of the data processing device 50.

The above-described power switch, initialization switch, display unit or debugging connection unit are not necessarily included in the data processing device 50. The data processing device 50 may include any one or more of these components.

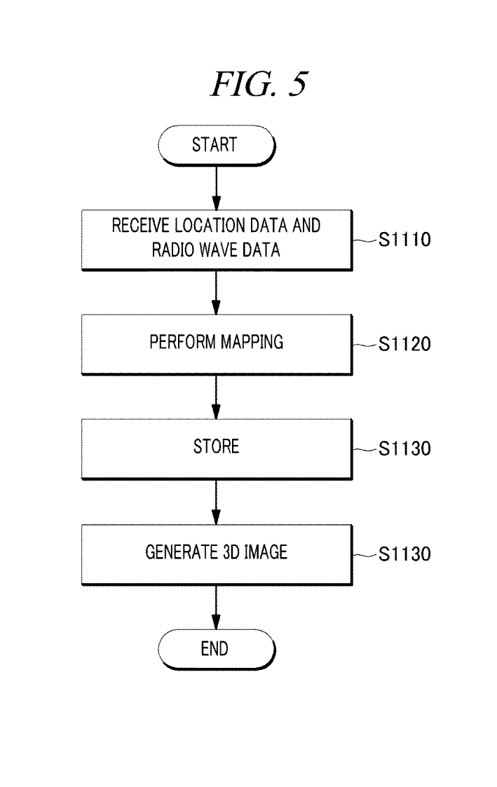

FIG. 5 is a flowchart provided to describe a method for processing data for radio wave measurement by a data processing device in accordance with an exemplary embodiment of the present disclosure.

Firstly, a data processing device receives location data of an ILS antenna located at a certain point and radio wave data measured by the ILS antenna (S1110). Herein, the location data may be measured by a GPS receiver, and the radio wave data may be measured by an ILS radio wave receiver. Further, since the GPS receiver and the ILS antenna are present at the same location, the GPS receiver may measure location data of the ILS antenna. Further, the location data include location coordinates of the ILS antenna or an angle measured from a location of a reference point.

Then, the data processing device performs mutual mapping between the received location data and the received radio wave data (S1120). That is, the data processing device creates messages with the received location data and radio wave data. Herein, the location data may include location coordinates or angles of the ILS antenna.

The data processing device calculates an angle of the ILS antenna from the reference point by using the received location data. In this case, the data processing device receives self-location measurement information of the ILS antenna by using a location measurement technology, and measures an angle of the ILS antenna relative to the location of the reference point by comparison with previously stored location information of the reference point. Such an angle may be calculated by the data processor itself, or may be an angle calculated by an external device and then received as location data by the data processing device.

If a location receiver receives location data at 1 PPS and a radio wave receiver receives radio wave data at 2 PPS, a data processor may perform mutual mapping between the location data at 1 PPS and the radio wave data at 2 PPS at a ratio of 1 to 2. Further, this can be created into a message at 1 PPS. Thus, it is possible to guarantee the precision of the radio wave data.

Meanwhile, before performing mutual mapping, the method may further include converting communication standards of an ILS radio wave receiver and a GPS receiver for communication between the ILS radio wave receiver and the GPS receiver, or interpreting protocols of the received location data and radio wave data for communication between the ILS radio wave receiver and the GPS receiver.

Then, the data processing device stores mapping result data in a database (S1130). This is because as mapping result data of the ILS antenna located at a certain point are accumulated, a radio wave signal received by the ILS antenna can be displayed as a 3D image with more precision.

Then, on the basis of the mapping result data, the data processing device generates a 3D image of the radio wave data measured from multiple measurement paths of the ILS antenna located at a certain point (S1140).

The data processing device may generate an image using interpolation. The data processing device may generate an image by a method in which an ILS antenna is aware of two or more values at a certain distance among continuous variables of radio wave data due to an influence such as spatial interference and a certain function value satisfying them is determined to calculate a function value with respect to a value of a radio wave data variable between the two values.

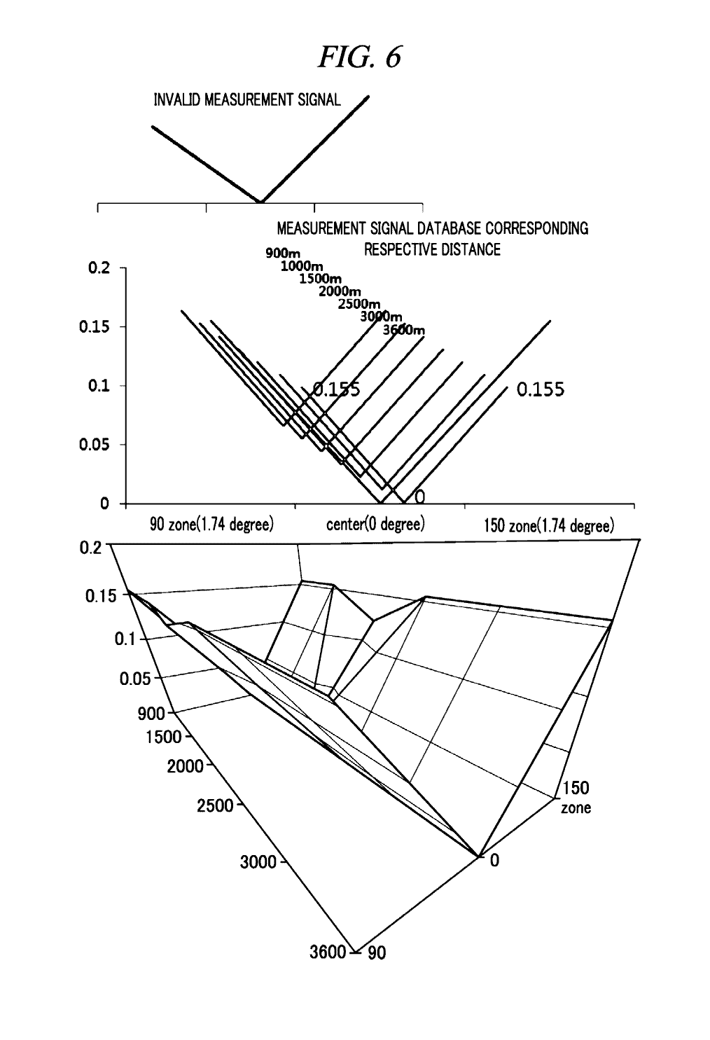

FIG. 6 illustrates an example of an image implemented by data processing in accordance with an exemplary embodiment of the present disclosure.

The data processing device and method in accordance with an exemplary embodiment of the present disclosure enable signal measurement at a certain location departing from the limitations of signal measurement at a fixed measurement location according to a conventional measurement method. Therefore, it is possible to measure an ILS radio wave signal by diverse methods. Thus, as illustrated in FIG. 6, it is possible to analyze an ILS radio wave pattern formed in on space in a 3D manner instead of a conventional 2D manner. Further, since the measured signals are formed into data and then automatically analyzed and displayed, a system can directly determine the performance of a facility on the basis of objective indicators to the exclusion of subjective factors during a test of the performance of the facility and can also increase the precision in analysis of the performance by minimizing error-generating factors.

For reference, each of components of the data processing device or data processing method in accordance with the embodiments of the present disclosure may imply software or hardware such as a field programmable gate array (FPGA) or an application specific integrated circuit (ASIC), and they carry out a predetermined function.

However, the components are not limited to the software or the hardware, and each of the components may be stored in an addressable storage medium or may be configured to implement one or more processors.

Accordingly, the components may include, for example, software, object-oriented software, classes, tasks, processes, functions, attributes, procedures, sub-routines, segments of program codes, drivers, firmware, micro codes, circuits, data, database, data structures, tables, arrays, variables and the like.

The components and functions thereof can be combined with each other or can be divided up into additional components.

Further, the above-described storage may be implemented with at least one of non-volatile memory such as cache, ROM (Read Only Memory), PROM (Programmable ROM), EPROM (Erasable Programmable ROM), EEPROM (Electrically Erasable Programmable ROM), and flash memory, volatile memory such as RAM (Random Access Memory), or a storage medium such as hard disk drive (HDD) and CD-ROM, but is not limited thereto.

The exemplary embodiments can be embodied in a storage medium including instruction codes executable by a computer or processor such as a program module executed by the computer or processor. A data structure in accordance with the exemplary embodiments can be stored in the storage medium executable by the computer or processor. A computer-readable medium can be any usable medium which can be accessed by the computer and includes all volatile/non-volatile and removable/non-removable media. Further, the computer-readable medium may include all computer storage and communication media. The computer storage medium includes all volatile/non-volatile and removable/non-removable media embodied by a certain method or technology for storing information such as a computer-readable instruction code, a data structure, a program module or other data. The communication medium typically includes the computer-readable instruction code, the data structure, the program module, or other data of a modulated data signal such as a carrier wave, or other transmission mechanism, and includes information transmission mediums.

The device and method of the present disclosure has been explained in relation to a specific embodiment, but its components or a part or all of its operation can be embodied by using a computer system having general-purpose hardware architecture.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. A data processing device for measuring a radio wave of an instrument landing system (hereinafter, referred to as “ILS”), comprising:
a location receiver configured to receive location data of an ILS antenna;
a radio wave receiver configured to receive radio wave data measured by the ILS antenna;
a data processor configured to perform mutual mapping between the location data and the radio wave data; and
a storage configured to store mapping result data of the data processor,
wherein the data processor generates a 3D image of the radio wave data measured from multiple measurement paths of the ILS antenna located at a certain point on the basis of the mapping result data, and
the location data are measured by a GPS receiver.

2. The data processing device of claim 1,
wherein the location receiver receives the location data including location coordinates of the ILS antenna or an angle measured from a location of a reference point.

3. The data processing device of claim 1,
wherein the data processor calculates an angle between the ILS antenna and a reference point using previously stored location information of the reference point, and performs mapping of the calculated angle to the radio wave data.

4. The data processing device of claim 1,
wherein the radio wave receiver receives the radio wave data of the ILS antenna from an ILS radio wave receiver, and
the data processor converts a communication standard of the ILS radio wave receiver or the GPS receiver for commination between the ILS receiver and the GPS receiver, or interprets protocols of the received location data and radio wave data for communication between the ILS receiver and the GPS receiver.

5. The data processing device of claim 1,
wherein the location data are location data at 1 PPS (pulse per second),
the radio wave data are radio wave data at 2 PPS, and
the data processor performs mapping between the location data at 1 PPS and the radio wave data at 2 PPS at a ratio of 1 to 2.

6. A data processing method for measuring a radio wave of an instrument landing system (hereinafter, referred to as “ILS”), comprising:
receiving location data of an ILS antenna;
receiving radio wave data measured by the ILS antenna;
performing mutual mapping between the location data and the radio wave data;
storing mapping result data; and
generating a 3D image of the radio wave data measured from multiple measurement paths of the ILS antenna located at a certain point on the basis of the mapping result data,
wherein the location data are measured by a GPS receiver.

7. The data processing method of claim 6,
wherein the step of receiving location data receives the location data including location coordinates of the ILS antenna or an angle measured from a location of a reference point.

8. The data processing method of claim 6,
wherein the step of performing mutual mapping calculates an angle between the ILS antenna and a reference point using previously stored location information of the reference point, and performs mapping of the calculated angle to the radio wave data.

9. The data processing method of claim 6,
wherein the step of receiving radio wave data receives the radio wave data of the ILS antenna from an ILS radio wave receiver, and
wherein the data processing method further includes:
converting a communication standard of the ILS radio wave receiver or the GPS receiver for communication between the ILS receiver and the GPS receiver, or interpreting protocols of the received location data and radio wave data for communication between the ILS receiver and the GPS receiver, before the step of performing mutual mapping.

10. The data processing method of claim 6,
wherein the location data are location data at 1 PPS (pulse per second),
the radio wave data are radio wave data at 2 PPS, and
wherein the step of performing mutual mapping performs mapping between the location data at 1 PPS and the radio wave data at 2 PSS at a ratio of 1 to 2.
